(19) United States
(12) Patent Application Publication
(10) Pub. No.: US 2006/0274489 A1
(43) Pub. Date: Dec. 7, 2006

(54) Securable visual screen cover device

(76) Inventor: James Kenneth Hawkins, Decatur, GA (US)

Correspondence Address: GEORGE R. REARDON, 3356 STATION COURT, LAWRENCVILLE, GA, 30044, US

(21) Appl. No.: 11/144,185

(22) Filed: Jun. 4, 2005

(51) Int. Cl. G06F 1/16

(52) U.S. Cl. 361/683

(57) ABSTRACT

The present invention relates generally to devices that regulate computer usage to selected times and durations. The present invention is comprised of a screen cover element, a locking element and a monitor cover element that connects the screen cover element to the locking element. The combination of these three elements is such that when deployed on a computer monitor computer usage is deterred due to the inability to view the monitor. The structure of this combination of these three elements is such that attempts to remove the securable monitor cover by unauthorized personnel, will be obvious to the authorized user or users.

### FIELD OF THE INVENTION

The present invention is directed to visual screen cover devices. More particularly, this invention relates to a device that will cover a screen, so that the screen cannot be viewed and so that the visual screen cover device can be secured such that only an authorized person can easily remove the monitor cover.

### BACKGROUND OF THE INVENTION

Numerous covers have been developed for computer monitors, some to minimize dust, some for decorative purposes, some for storage purposes, etc. For example U.S. Pat. No. 6,209,973 issued to Steinberg, describes a cover for a computer monitor having a visual display screen. The cover includes a containment member having a top panel, a pair of side panels, as well as plurality of appendages.

Further, U.S. Pat. No. 6,133,966, issued to Dyballa, describes a monitor cover having a frame securable against the front shape of a monitor, a covering on the frame and a plurality of covering elements vertically disposed on the frame.

Additionally, U.S. Pat. No. 6,402,269, issued to Roth, describes a decorative cover for a computer monitor made of a pliable material that enables it to be placed over a computer monitor to protect it from hazardous elements. The decorative cover is in the form of an animal to enhance the appeal of the computer. There is also a conductive material disposed inside of the decorative cover to help discharge electrostatic charges.

Also, U.S. Pat. No. 6,592,193, issued to Curry, describes an apparatus which rotatably covers and exposes a computer monitor screen. Storage and display containers and shelves are affixed to the inside and outside surfaces of the apparatus allowing a computer operator to store and display items.

Yet another approach is found in U.S. Pat. No. 6,826,859, issued to Lin, which describes a decorative shade for a video display with a screen. The decorative shade has a window with an opening to attach to the video display in front of the screen, a rolling device mounted inside the window and a blind wound on the rolling device to selectively cover the screen. When the blind covers the screen, the decorative shade protects and keeps dust off the video screen.

U.S. Pat. No. 5,894,878, issued to Morgan, describes a covered casing assembly which includes a fabric member made of an elastic material that is stretched over a casing and having at least one opening surrounding an accessible feature of the casing.

Still another approach is found in U.S. Pat. No. 5,759,644, issued to Stanley, which describes a decorative cover for computer monitors having a covering material assembly made of a flexible covering material configured to conform to the forward portion of a computer monitor. The cover is held in place by elastic banding and/or hook and loop fastening strips.

While each of these devices addressed the problems to which they were directed, none of them were designed to regulate computer usage or television usage. Currently, a variety of approaches are used to limit computer usage, at home, in business, healthcare and government security applications. In the home, for example, parents can verbally instruct their children on allowable usage. This instruction may be in the form of the number of hours per day, the time periods of the day, the days of the week, the prerequisite that homework must be completed, etc. Software and hardware solutions are also available in the marketplace to address the problem of regulating computer usage. However, currently children generally have a higher level of computer savvy than their parents and can devise ways to circumvent existing regulation methods. Other problems exist that are not addressed by the cited patents.

Improvements are needed to give parents a low-tech solution that will give them the peace of mind that their children are indeed using the computer only during the times that the parent allows. Additionally, improvements are needed to give a cost-effective alternative to regulate computer usage for businesses, healthcare and government security environments. Therefore, it is an object of the present invention to provide a securable visual screen cover device that overcomes these and other problems.

It is an object of the present invention to provide a securable visual screen cover device that prevents usage of a computer during non-authorized times.

It is an object of the present invention to provide a securable visual screen cover device that is easy to deploy.

It is an object of the present invention to provide a securable visual screen cover device that can be made of inexpensive materials.

It is a further object of the present invention to provide a securable visual screen device that can be easily constructed by hand or that is capable of being manufactured using existing machinery.

It is a further object of the present invention to provide a securable visual screen device that can have a variety of devices removably attached or permanently affixed for decorative or utility purposes.

### SUMMARY OF THE INVENTION

The aforementioned and other objects were achieved, and the above-mentioned disadvantages overcome, by the present invention, by providing a securable visual screen cover device that requires no to minimal technical skills to deploy.

The present invention is directed to regulating computer usage to the times directed by the user of the securable visual screen cover device that is comprised of an opaque panel that restricts viewing access to a computer monitor. This opaque panel may be made from any number of materials, e.g. plastic, composites, fabric, metal, laminates, wood or wood products. The opaque panel may have any number of additional devices attached to its front. Securing the opaque panel to the monitor could utilize a drawstring with a lock, a hinge and lock, or locking mechanisms, and the like. In a preferred embodiment of the invention the securable visual screen cover device is comprised of a screen cover element, a locking element and a monitor cover element that connects the screen cover element to the locking element. The combination of these three elements is such that when deployed on a computer monitor computer usage is deterred due to the inability to view the monitor. The structure of this combination of these three elements is such that attempts to remove the securable visual screen cover by unauthorized personnel, e.g. children, will be obvious to the user or users, e.g. the parents.

In general, the screen cover element will be in the form of one or more flat panels. The screen cover will preferably be opaque. The material for the panels is preferably plastic, but may be of other materials, e.g. composites, fabric, metal, laminates, wood, or wood products. In general the locking element may employ one or more of a locking device, e.g. a combination lock, a keyed lock, a lock plate, seals and the like. Depending on the age of the child, the locking device may be as simple as a cord lock through which one or more of a drawstring cord, cable or chain pass. The monitor cover element may entail the use of fabric, hinges, adhesives, snap rivets, fasteners, drawstrings, cables, chains, drawstring channels and the like, in order to facilitate connection with the screen cover element and the locking element.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 shows a right side plan view of a securable visual screen cover device on a computer monitor according to a preferred embodiment of the present invention.

FIG. 2 shows a front plan view of a securable visual screen cover device according to an alternate embodiment of the present invention.

FIG. 3 shows a front plan view of a securable visual screen cover device with a channel element according to an alternate embodiment of the present invention.

FIG. 4 shows a detailed side view of a portion of a securable visual screen cover device highlighting the channel according to an alternate embodiment of the present invention.

FIG. 5 shows a front plan view of a securable visual screen cover device highlighting the use of a mesh fabric according to an alternate embodiment of the present invention.

FIG. 6 shows a detailed side plan view of a securable visual screen cover device showing how a fabric element may be deployed between two panel elements according to an alternate embodiment of the present invention.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to a securable visual screen cover device. Nonetheless, the characteristics and parameters pertaining to various embodiments of the device and methods described herein may be applicable for other uses.

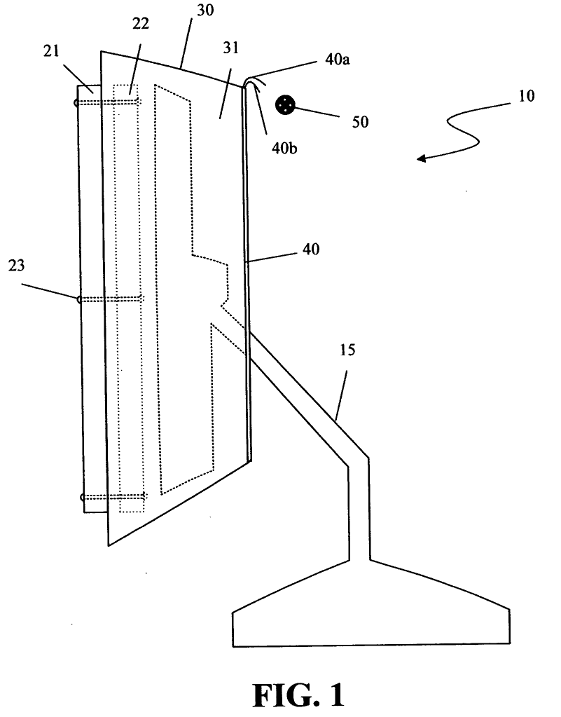

Referring to FIG. 1, an embodiment of the present invention is shown as device 10. Device 10 is further comprised of panel element 20. Panel element 20 is further comprised of outside panel 21 and inside panel 22, which are connected to each other with a plurality of fastener 23. Device 10 is further comprised of monitor cover element 30. Monitor cover element 30 is further comprised of fabric 31, which encloses the screen portion of monitor assembly 15 and is secured between outside panel 21 and inside panel 22 by fastener 23. Monitor cover element 30 is further comprised of drawstring channel 40, which contains first drawstring 40a and second drawstring 40b. Locking element 50 is a cord lock through which first drawstring 40a and second drawstring 40b are pulled through to tighten fabric 31 around the screen portion of monitor assembly 15. In an alternative embodiment, device 10 is further comprised of monitor assembly 15.

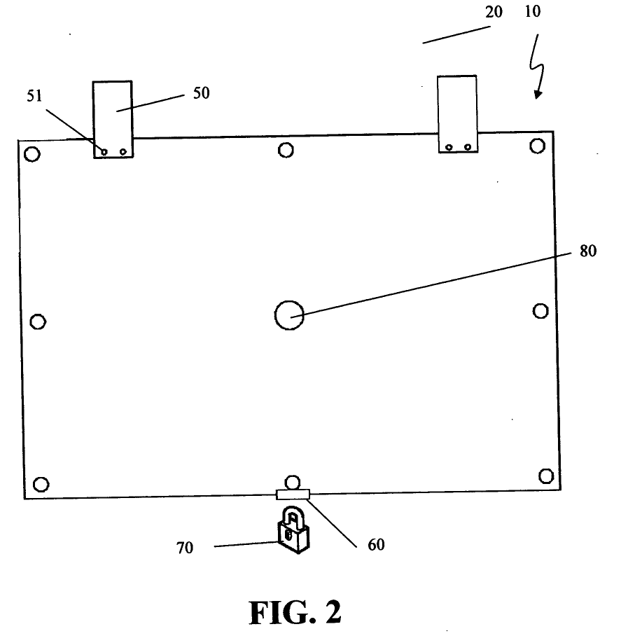

Referring to FIG. 2, in another embodiment of the present invention device 10 is comprised of panel element 20. Panel element 20 is further comprised of attachment recess 80, which is operable for removable attachment of decorative and useful devices, e.g. a white board, a writing surface, a cork board, a picture frame, sports memorabilia, entertainment items. Monitor element 30 is comprised of a plurality of hinge 50. Hinge 50 is further comprised of at least one of hinge fastener 51. Hinge fastener 51 attaches hinge 50 to panel element 20 as shown. Each hinge 50 is affixed to the top of the monitor using a strong adhesive. Locking element 50 is comprised of lock plate 60 which is affixed to the bottom of the monitor. Locking element 50 is further comprised of lock 70 which engages lock plate 60 to secure panel element 20.

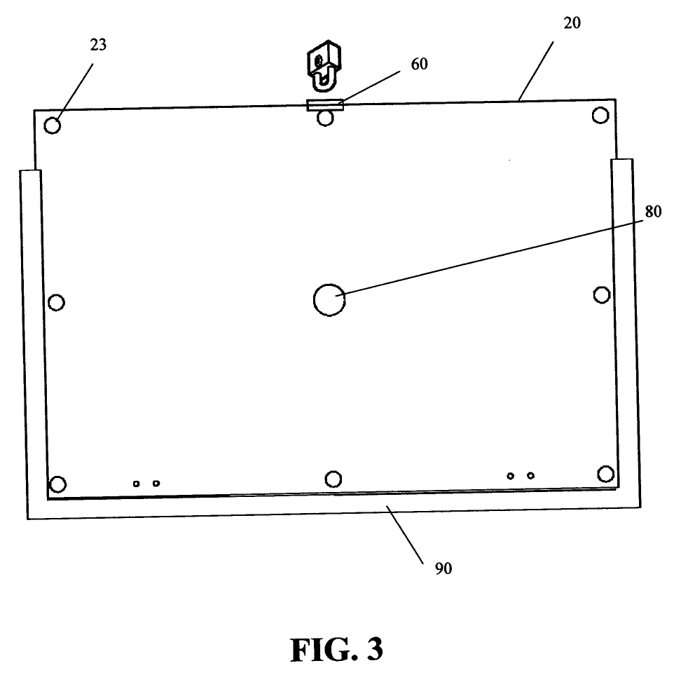

Referring now to FIG. 3, in another embodiment of the present invention, panel element 20 is shown with a plurality of fastener 23, attachment recess 80 and channel 90.

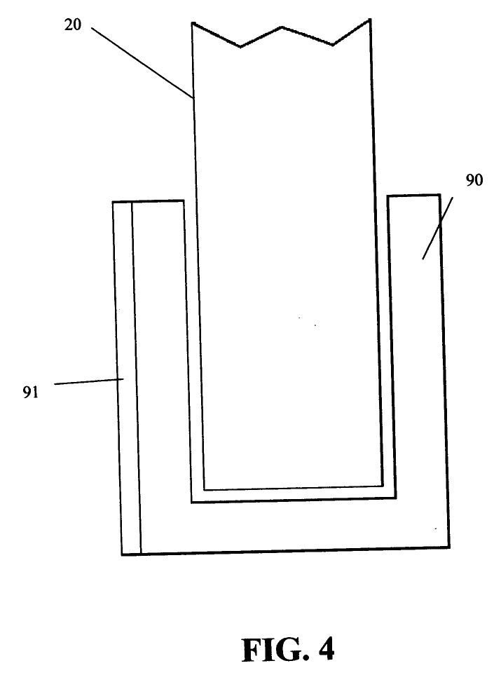

Referring now to FIG. 4, further detail of channel 90 is shown by a side view showing how adhesive 91 is disposed on the side of channel 90 that is in contact with the monitor, and showing how panel element 20 can slide within channel 90. Referring again to FIG. 3 panel element 20 slides up and out of channel 90 once lock 70 is removed from lock plate 60. Panel element 20 slides down and in channel 90 and lock 70 engages lock plate 60 in order to secure panel element 20 to the monitor.

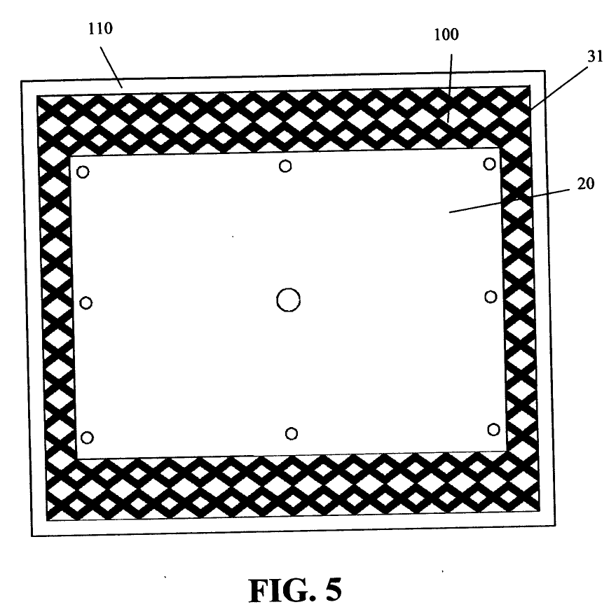

Referring now to FIG. 5, an embodiment of the present invention is shown where fabric 31 is comprised of mesh 100. Mesh 100 is affixed to panel element 20 at its inner periphery and has drawstring channel 110 at its outer periphery.

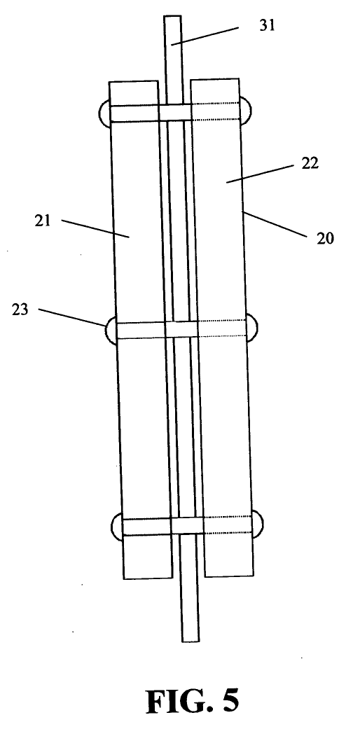

Referring now to FIG. 6, panel element 20 is shown in a side plan view to show how fabric 31 is secured between outer panel 21 and inner panel 22 by a plurality of fastener 23 engaging fabric 31.

Other embodiments, uses and advantages of the present invention will be apparent to those skilled in the art from consideration of the specification and practice of the invention disclosed herein. The specification and examples should be considered exemplary only.

What is claimed is:

1) A securable visual screen cover device for a monitor comprising:
a panel element;
a monitor cover element; and
a locking element.

2) The securable visual screen cover device according to claim 1,
wherein said panel element is -further comprised of an inside panel and an outside panel that are attached to each other by a plurality of fasteners;
wherein said monitor cover element is further comprised of fabric that is operably affixed to said panel element, and wherein said fabric is further comprised of at least one drawstring operable within a drawstring channel for enclosing a monitor; and
wherein said locking element is a cord lock operable for engaging said at least one drawstring.

3) The securable visual screen cover device according to claim 2, wherein said panel element is further comprised of a recess operable for engaging an attachment.

4) The securable visual screen cover device according to claim 3, wherein said attachment is selected from the group including a whiteboard, a writing surface, a cork board, a picture frame, sports memorabilia, an entertainment item.

5) The securable visual screen cover device according to claim 4, further comprising a computer monitor.

6) The securable visual screen cover device according to claim 1, wherein said monitor element is comprised of at least one hinge operable for affixing said hinge to a monitor;
wherein said locking element is comprised of a lock plate affixed to said monitor and a lock operable for lockingly engaging said lock plate.

7) The securable visual screen cover device according to claim 6, further comprising a monitor.

8) The securable visual screen cover device according to claim 1, wherein said monitor cover element is comprised of a channel affixed to said monitor, wherein said channel is operable to allow said panel element to slide into said channel and cover the screen of said monitor and to slide out of said channel and uncover said screen, wherein said locking element is comprised of a lock plate affixed to said monitor, wherein said locking element is further comprised of a lock operable for lockingly engaging said lock plate.

9) The securable visual screen cover device according to claim 8, further comprising a monitor.
